(19) United States
(12) Patent Application Publication
(10) Pub. No.: US 2009/0134744 A1
(43) Pub. Date: May 28, 2009

(54) Ring type piezoelectric ultrasonic resonator and piezoelectric ultrasonic rotary motor using the same

(75) Inventors: Seok Jin Yoon, Seoul (KR); Hyun Jai Kim, Seoul (KR); Chong Yun Kang, Seoul (KR); Hyun Cheol Song, Seoul (KR)

Correspondence Address: BACON & THOMAS, PLLC, 625 SLATERS LANE, FOURTH FLOOR, ALEXANDRIA, VA, 22314-1176, US

(73) Assignee: KOREA INSTITUTE OF SCIENCE AND TECHNOLOGY, Seoul (KR)

(21) Appl. No.: 12/292,359

(22) Filed: Nov. 18, 2008

(30) Foreign Application Priority Data
Nov. 27, 2007 (KR) 10-2007-0121559

(51) Int. Cl. H02N 2/16

(52) U.S. Cl. 310/323.06

(57) ABSTRACT

A ring type piezoelectric ultrasonic resonator includes a piezoelectric ceramic segmented for each quarter of wavelength of an applied AC electric field, wherein the piezoelectric ceramic is alternately polarized in polarization units each having two segments, and a sine wave AC electric field and a sine wave AC electric field having a predetermined phase difference from the sine wave AC electric field are alternately applied to each of the segments. Further, the number of the segments of the piezoelectric ceramic is an integral multiple of 4. Moreover, the sine wave AC electric field applied to each of the segments of the piezoelectric ceramic has a phase difference of 90-degree with respect to adjacent segments.

### FIELD OF THE INVENTION

The present invention relates to a ring type piezoelectric ultrasonic resonator, and more particularly, to a ring type piezoelectric ultrasonic resonator and a piezoelectric ultrasonic rotary motor using the same, which can generate an elliptical mechanical displacement to a ring type resonator to rotate a rotor, by applying AC electric fields of two different phases to piezoelectric ceramics.

### BACKGROUND OF THE INVENTION

As well-known in the art, a piezoelectric ultrasonic motor has several merits that it can directly drive with a high torque, though at a low speed, has a fast response time, and can be used in a wide velocity range. Further, the piezoelectric ultrasonic motor has additional merits that it can be controlled, without slippage by compression of a mover and a stator, to achieve precision position control, and can produce a high output for weight. Such a piezoelectric ultrasonic motor can be employed for both a rotary motor and linear motor. Meanwhile, as a resonator of a rotary motor, a ring type piezoelectric ultrasonic resonator may be used, which is adopted in various fields, such as a camera lens driving motor, a card feed motor of a public telephone, a driving motor of a foldable side mirror of a vehicle, a power source of a movable headrest of a vehicle, a roll curtain winding motor, a volume motor for remote control stereo, etc. As a resonator of a rotary piezoelectric ultrasonic motor, a ring type resonator may be used.

Hereinafter, a conventional ring type piezoelectric ultrasonic resonator will be described in more detail with reference to FIG. 1. FIG. 1 shows a plan view of a conventional ring type piezoelectric ultrasonic resonator. As shown in the drawing, a piezoelectric ceramic of the ring type ultrasonic resonator is partitioned into a plurality of segments. Most of the segments 10 have a length of ½ of the wavelength of an applied electric field, and are alternately polarized. One of the plurality of segments is a first dummy portion 11, which has a wavelength that is ¾ of the wavelength of the applied electric field and is not polarized. A second dummy portion 12, which is the segment facing the first dummy portion 11, has a length of ¼ of the wavelength of the applied electric field and is not polarized.

AC electric fields of sine waves having a phase difference of 90-degree are applied to the segments at both sides with respect to the first and the second dummy portions 11 and 12. In other words, in the drawing, an AC electric field of A sin wt is applied to the segments 1 at the right side of the first and the second dummy portions 11 and 12, and an AC electric field of A cos wt is applied to the segments 2 at the left side thereof. When an electric field is applied, each of the segments vibrates. Since the lengths of the first and the second dummy portions 11 and 12 are different from each other, the vibrations of the segments are interfered to form a traveling wave. That is, if the lengths of all the segments are the same, a standing wave is supposed to be formed, but the first and the second dummy portions 11 and 12 cause to form a traveling wave.

The conventional ring type piezoelectric ultrasonic resonator as mentioned above, however, has some problems that a torque at each point may not be uniform because there are dummy portions which are passively vibrated without having any electric field applied, and the overall output of the resonator may be lowered since the output at the dummy portions is zero.

### SUMMARY OF THE INVENTION

It is, therefore, an object of the present invention to provide a ring type piezoelectric ultrasonic resonator which provides same torque at every point and also provides a high output by disposing piezoelectric ceramic segments of same size in a ring type without forming dummy portions.

In accordance with one aspect of the present invention, there is provided a ring type piezoelectric ultrasonic resonator, including a piezoelectric ceramic segmented for each quarter of wavelength of an applied AC electric field, wherein the piezoelectric ceramic is alternately polarized in polarization units each having two segments, and a sine wave AC electric field and a sine wave AC electric field having a predetermined phase difference from the sine wave AC electric field are alternately applied to each of the segments.

Further, the number of the segments of the piezoelectric ceramic is an integral multiple of 4.

Moreover, the sine wave AC electric field applied to each of the segments of the piezoelectric ceramic has a phase difference of 90-degree with respect to adjacent segments.

It is preferred that first electrodes are formed on the outer sides of the first segments of the polarization units, and second electrodes are formed on inner sides of the second segments of the polarization units, the first and the second electrodes being alternately connected to the segments one by one. Further, if a sine wave AC electric filed applied to the first electrodes has a phase difference of 90-degree slower than a sine wave AC electric field applied to the second electrodes, the piezoelectric ceramic generates a traveling wave in a clockwise direction, while if a sine wave AC electric field applied to the first electrodes has a phase difference of 90-degree faster than a sine wave AC electric field applied to the second electrodes, the piezoelectric ceramic generates a traveling wave in a counterclockwise direction.

In accordance with another aspect of the present invention, there is provided a piezoelectric ultrasonic rotary motor, including: a ring type piezoelectric ultrasonic resonator segmented into an integral multiple of 4 for each quarter of wavelength of an applied electric field; a stator for transmitting vibration of the resonator by contact with the resonator; a rotor rotating by a frictional force generated by a vibration of the stator; a rotary shaft attached to a center of the rotor; and a housing accommodating the resonator, the stator, the rotor, and the rotary shaft, the rotary shaft projecting therefrom, wherein the resonator is alternately polarized in polarization units each having two segments, and a sine wave AC electric field and a sine wave AC electric field having a phase difference of 90-degree from the previous sine wave AC electric field are alternately applied to the segments.

It is preferred that a friction ring for direct contact with the stator is coupled to a lower portion of the rotor.

Further, the stator includes a base portion contacting the resonator and a projection projected toward the rotor from the base portion, the projection being deformed while contacting with the friction ring so as to provide a frictional force to the friction ring.

Moreover, the piezoelectric ultrasonic rotary motor, further includes a plate spring for pressing the rotor to the stator.

### BRIEF DESCRIPTION OF THE DRAWINGS

The above and other objects and features of the present invention will become apparent from the following description of preferred embodiments, given in conjunction with the accompanying drawings, in which:

FIG. 1 shows a plan view of a conventional ring type piezoelectric ultrasonic resonator;

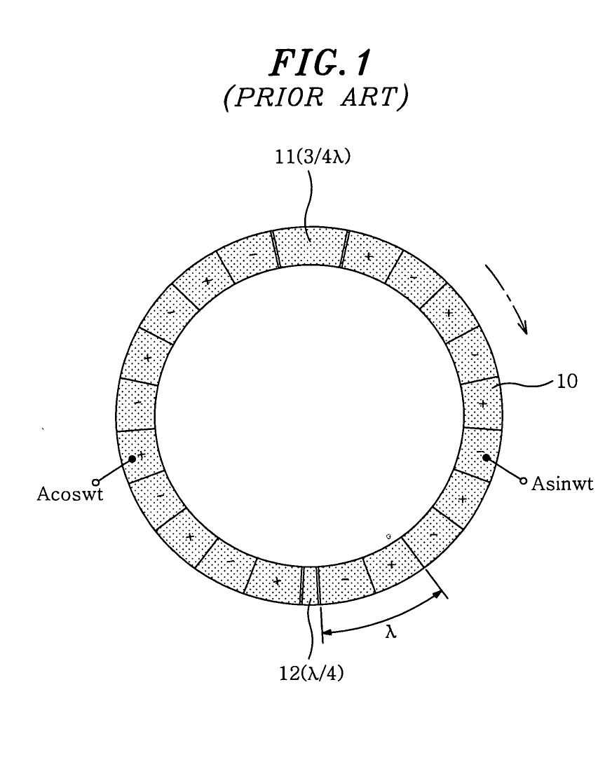

FIG. 2 illustrates a plan view of a ring type piezoelectric ultrasonic resonator in accordance with an embodiment of the present invention;

FIG. 3 is a graph showing a vibration displacement when an electric field is applied to the ring type piezoelectric ultrasonic resonator of FIG. 2;

FIG. 4 is a perspective view showing deformation of the ring type piezoelectric ultrasonic resonator of FIG. 2 with time;

FIG. 5 is a perspective view showing deformation of the ring type piezoelectric ultrasonic resonator of FIG. 2 with time when an electric field applied to the ring type piezoelectric ultrasonic resonator is applied in a reverse manner;

FIG. 6 illustrates a cross sectional view of a piezoelectric ultrasonic rotary motor using the piezoelectric ultrasonic resonator in accordance with the present invention; and

FIGS. 7A and 7B provide cross sectional views for explaining a process of rotating a rotor by using the piezoelectric ultrasonic resonator in accordance with the present invention.

### DETAILED DESCRIPTION OF THE PREFERRED EMBODIMENT

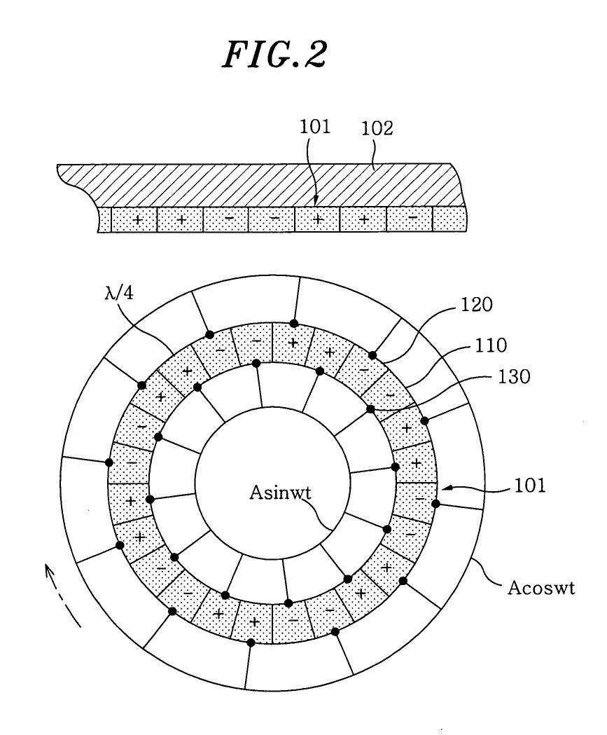

Hereinafter, an exemplary embodiment of a ring type piezoelectric ultrasonic resonator in accordance with the present invention will be described in detail with reference to FIGS. 2 to 6.

FIG. 2 shows a plan view of a ring type piezoelectric ultrasonic resonator in accordance with an exemplary embodiment of the present invention. The ring type piezoelectric ultrasonic resonator 101 as shown in FIG. 2 is pressed against a stator 102, and thus, vibration of the resonator 101 is transmitted as it is to the stator 102. A traveling wave of the resonator 101 forms a traveling wave even in the stator 102, and such a wave is converted into a frictional force to rotate a rotor (not shown). The piezoelectric ultrasonic resonator 101 includes piezoelectric ceramics segmented for each quarter of the wavelength of an applied electric field, wherein segments 110 are alternately polarized in pairs. The length of the circumference of the piezoelectric ultrasonic resonator 101 is an integral multiple of the wavelength of the electric field provided thereto. Therefore, the circumferential length of the piezoelectric ceramic is an integral multiple of the wavelength of the applied electric field. First electrodes 120 are provided on the outer sides of the segments 110 to apply a sine wave AC electric field, and second electrodes 130 are provided on the inner sides of adjacent segments 110 to apply a sine wave AC electric field having a phase difference of 90-degree slower than the electric field applied to the first electrodes. In this embodiment, the segments 110 are alternately polarized in pairs. In the drawing, (+) or (−) represents the state of the ceramic vertically polarized. If two adjacent segments are polarized in the same direction, the next two adjacent segments are polarized in a direction opposite to that of the previous segments. An AC electric field of A sin wt is applied to the inner sides of the segments 110, and an AC electric field of A cos wt is applied to the outer sides of adjacent segments 110. Such an electric field is alternately applied to each of the segments. That is, when a sine wave AC current is applied to one segment, an AC current having a phase difference of 90-degree faster or slower than the sine wave AC current is applied to adjacent segments. As a result, (−) polarization and a sin wave, (+) polarization and a cos wave, (+) polarization and a sin wave, and (−) polarization and a cos wave successively correspond to each other.

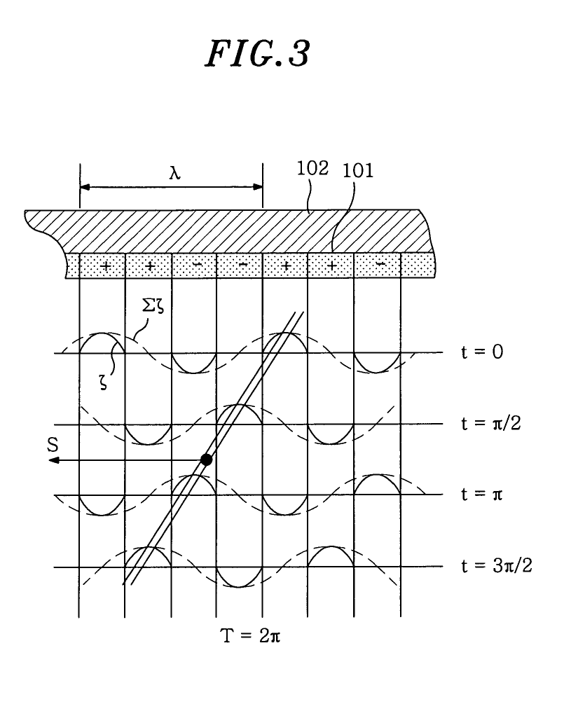

FIG. 3 is a graph showing a vibration displacement when an electric field is applied to the ring type piezoelectric ultrasonic resonator of FIG. 2. The displacement formed by the successive arrangement of polarizations and electric fields as shown in FIG. 2 can be expressed as follow:

ξ₁(x, t)=Ae^{jwt} cos kx Eq. (1)

ξ₂(x, t)=Ae^{jwt+π/2} cos k(x+λ/4) Eq. (2)

ξ₃(x, t)=Ae^{jwt+π} cos k(x+λ/2) Eq. (3)

ξ₃(x, t)=Ae^{jwt+3π/2} cos k(x+3λ/4) Eq. (4)

wherein A denotes amplitude, t denotes time, w denotes angular frequency, k(=w/c) denotes wave number, c denotes a traveling speed of wave, and λ denotes wavelength.

FIG. 3 shows such a displacement. As shown therein, a displacement at each segment changes and vibrates with time t. As for the location of the maximum amplitude, it can be seen that the vibration of the ring type piezoelectric ultrasonic resonator is a traveling wave that travels in an S direction.

Typically, a piezoelectric ceramic resonator is formed by a ceramic piezoelectric material stacked on the surface of an elastic substrate made of metal or the like. However, such a structure is well-known in the art, and therefore, a detailed description thereof will be omitted here.

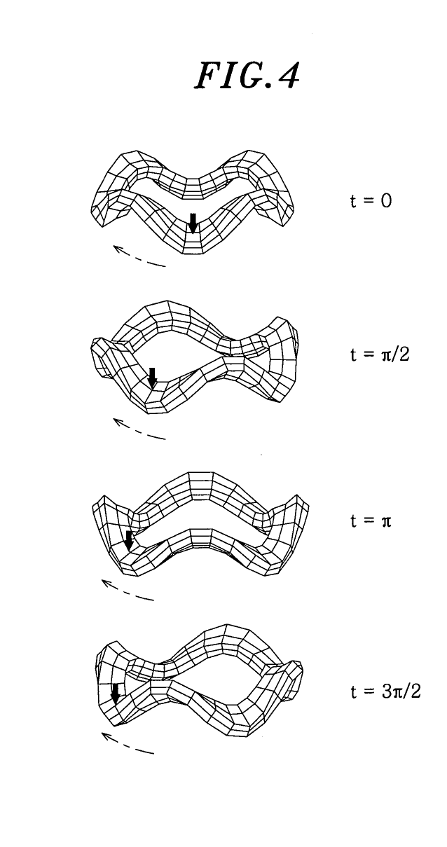

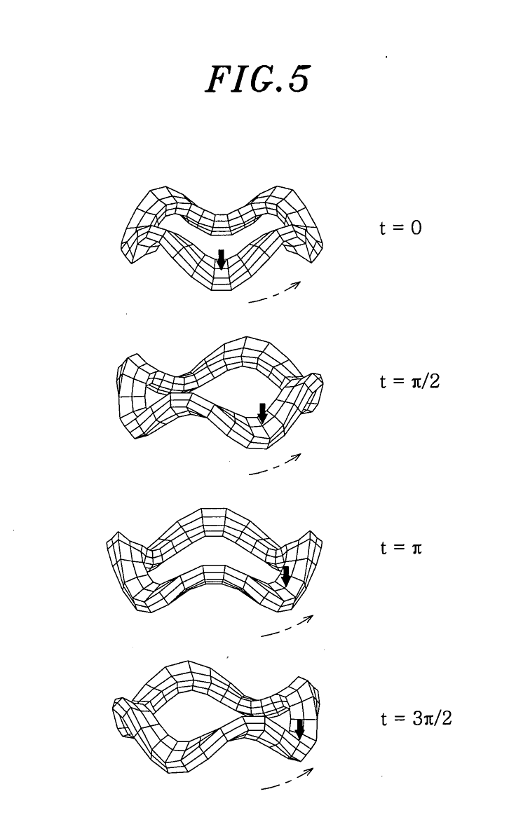

Hereinafter, the operation and effects of the ring type piezoelectric ultrasonic resonator in accordance with the present invention will be described in more detail with reference to FIGS. 4 and 5.

FIG. 4 is a perspective view showing deformation of the ring type piezoelectric ultrasonic resonator of FIG. 2 with time, and FIG. 5 is a perspective view showing deformation of the ring type piezoelectric ultrasonic resonator of FIG. 2 with time when a sine wave AC electric field applied to the first electrodes has a phase difference of 90-degree faster than a sine wave AC electric field applied to the second electrodes.

When an electric field is applied, the ring type piezoelectric ultrasonic resonator is deformed. Since the applied electric field is in the form of a sine wave having a predetermined cycle, such deformation also vibrates in a predetermined cycle. As described above, vibration is a traveling wave.

FIG. 4 shows a case where an AC electric field of A cos wt is applied to first segments of polarization units each including two segments having the same polarization among the segments of the piezoelectric ceramic, and an AC electric field of A sin wt is applied to the second segments thereof. In this case, a wave is transmitted in a clockwise direction.

On the contrary, FIG. 5 shows a case where an AC electric field of A sin wt is applied to the first segments of polarization units, and an AC electric field of A cos wt is applied to the second segments thereof. In this case, a wave is transmitted in a counterclockwise direction. In other words, the adjustment of an electric field can change the direction of rotation, thereby effectively controlling the direction of rotation.

The segments of the ring type piezoelectric ultrasonic resonator all have the same interval, thus making its production easier. In addition, there is a merit of a sharp increase in output by vibration of all the segments because there is no dummy portion.

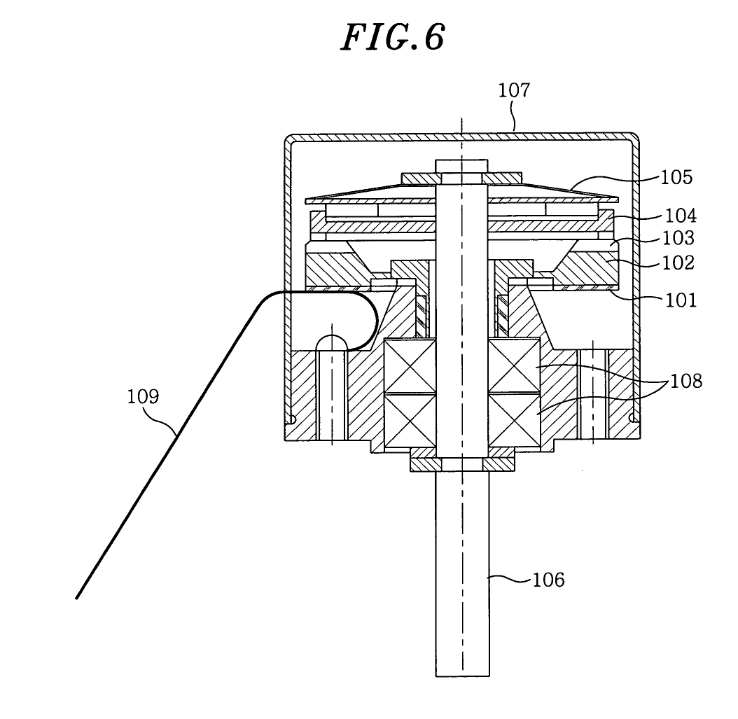

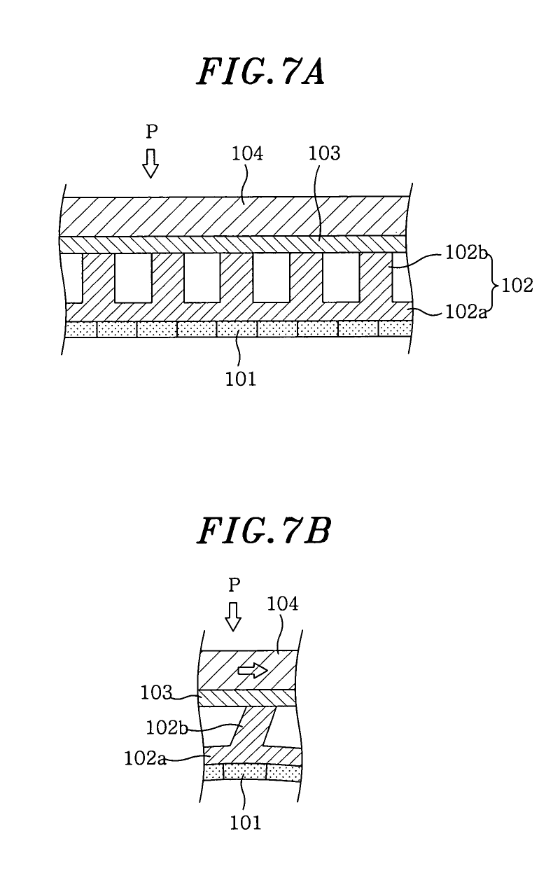

Hereinafter, a piezoelectric ultrasonic rotary motor to which the piezoelectric ultrasonic resonator in accordance with the present invention is applied will be described in detail with reference to FIGS. 6 to 7B.

FIG. 6 shows a cross sectional view of a piezoelectric ultrasonic rotary motor using the ring type piezoelectric ultrasonic resonator in accordance with the present invention, and FIGS. 7A and 7B are cross sectional views showing a process of rotating a rotor by using the ring type piezoelectric ultrasonic resonator in accordance with the present invention.

As shown in FIGS. 6 to 7B, a rotary module for a motor includes a ring type piezoelectric ultrasonic resonator 101, a stator 102 contacting the ring type piezoelectric ultrasonic resonator 101, a rotor 104 of a disc shape, a friction ring 103 which is coupled to the rotor 104 and is in contact with the stator 102 to receive a frictional force, thereby providing a rotational force to the rotor 104, a plate spring 105 for pressing the rotor 104 to the stator 102, and a rotary shaft 106. Specifically, the stator 102 includes a base portion 102a contacting the ring type piezoelectric ultrasonic resonator 101 and a projection 102b projecting toward the rotor 104 from the base portion 102a. The projection 102b is deformed, with it being in contact with the friction ring 103, to thus provide a frictional force to the friction ring 103.

The rotary module is accommodated within a housing 107 of the motor, and the rotary shaft 106 is rotatably supported by a bearing 108 provided in the housing 107. The ring type piezoelectric ultrasonic resonator 101 is coupled to the housing 107, and is supplied with an electric field via wires 109. The supply of an electric field may be achieved through the use of a PCB.

As shown in FIGS. 7A and 7B, the projection 102b provides a frictional force to the rotor 104 of a disc type according to a traveling wave. The rotor 104 is pressed with load P by the plate spring 105. FIG. 7A shows an initial state, and FIG. 7B shows a state in which the stator 102 is deformed with the deformation of the ring type piezoelectric ultrasonic resonator and, therefore, the rotor 104 is moved. The stator is not rotated but deformed by vibration to generate a traveling wave. When the projection 102b is moved upward by the deformation of the stator 102, the rotor 104 is pressed with a predetermined pressure P, and thus, the projection 102b is deformed in a rotary direction and provides a frictional force to the friction ring 103 in a rotary direction. The friction ring 103 and the rotor 104 coupled thereto are pushed by the deformation of the projection 102b to generate a displacement in a rotary direction, thereby rotating the rotor 104. Such a rotary motor has a high output and a strong torque, and can be precisely controlled, compared to the conventional rotary motor.

According to the present invention, energy at every point is uniform and the output of the resonator increases, by segmenting a piezoelectric ceramic by the same length without forming dummy portions in the piezoelectric ceramic, alternately polarizing each of segments in polarization units each having two segments, and alternately applying a sine wave AC electric field having a phase difference of 90 degrees to each of the segments.

While the invention has been shown and described with respect to the preferred embodiments, it will be understood by those skilled in the art that various changes and modification may be made without departing from the scope of the invention as defined in the following claims.

What is claimed is:

1. A ring type piezoelectric ultrasonic resonator, comprising:
a piezoelectric ceramic segmented for each quarter of wavelength of an applied AC electric field,
wherein the piezoelectric ceramic is alternately polarized in polarization units each having two segments, and
a sine wave AC electric field and a sine wave AC electric field having a predetermined phase difference from the sine wave AC electric field are alternately applied to each of the segments.

2. The ring type piezoelectric ultrasonic resonator of claim 1, wherein the number of the segments of the piezoelectric ceramic is an integral multiple of 4.

3. The ring type piezoelectric ultrasonic resonator of claim 1, wherein the sine wave AC electric field applied to each of the segments of the piezoelectric ceramic has a phase difference of 90-degree with respect to adjacent segments.

4. The ring type piezoelectric ultrasonic resonator of claim 1, wherein first electrodes are formed on the outer sides of the first segments of the polarization units, and second electrodes are formed on inner sides of the second segments of the polarization units, the first and the second electrodes being alternately connected to the segments one by one, and
if a sine wave AC electric filed applied to the first electrodes has a phase difference of 90-degree slower than a sine wave AC electric field applied to the second electrodes, the piezoelectric ceramic generates a traveling wave in a clockwise direction, while if a sine wave AC electric field applied to the first electrodes has a phase difference of 90-degree faster than a sine wave AC electric field applied to the second electrodes, the piezoelectric ceramic generates a traveling wave in a counterclockwise direction.

5. A piezoelectric ultrasonic rotary motor, comprising:
a ring type piezoelectric ultrasonic resonator segmented into an integral multiple of 4 for each quarter of wavelength of an applied electric field;
a stator for transmitting vibration of the resonator by contact with the resonator;
a rotor rotating by a frictional force generated by a vibration of the stator;
a rotary shaft attached to a center of the rotor; and
a housing accommodating the resonator, the stator, the rotor, and the rotary shaft, the rotary shaft projecting therefrom,
wherein the resonator is alternately polarized in polarization units each having two segments, and
a sine wave AC electric field and a sine wave AC electric field having a phase difference of 90-degree from the previous sine wave AC electric field are alternately applied to the segments.

6. The piezoelectric ultrasonic rotary motor of claim 5, wherein a friction ring for direct contact with the stator is coupled to a lower portion of the rotor.

7. The piezoelectric ultrasonic rotary motor of claim 6, wherein the stator includes a base portion contacting the resonator and a projection projected toward the rotor from the base portion, the projection being deformed while contacting with the friction ring so as to provide a frictional force to the friction ring.

8. The piezoelectric ultrasonic rotary motor of claim 5, further comprising a plate spring for pressing the rotor to the stator.
